(19) United States
(12) Patent Application Publication
(10) Pub. No.: US 2026/0204181 A1
(43) Pub. Date: Jul. 16, 2026

(54) PROCESS FOR TEACHING AND DEMONSTRATING HOW TO INTERPRET X-RAY IMAGES, BLUE-PRINTS, AND OTHER TWO-DIMENSIONAL REPRESENTATIONS OF THREE-DIMENSIONAL OBJECTS, INCLUDING MODELS FOR SAME

(71) Applicant: Roger Bruce Bender, Mount Vernon, NY (US)

(72) Inventor: Roger Bruce Bender, Mount Vernon, NY (US)

(21) Appl. No.: 19/022,885

(22) Filed: Jan. 15, 2025

(51) Int. Cl. G09B 23/28

(52) U.S. Cl. CPC G09B 23/286

(57) ABSTRACT

Presented is an invention in which visible light is substituted for damaging radiation, enabling students to learn about radiology through active learning (e.g. by manipulation of a study's subject and seeing, in real time, the resulting changes in the generated image) but without exposure to damaging radiation. The invention also allows student and senior practitioners to practice radiological techniques (e.g. patient positioning, fluoroscopy) without radiation exposure. The invention also allows demonstration of the relationship between a three-dimensional object and its two-dimensional depictions, such as between a machine part and that part's views on a technical drawing.

### BACKGROUND OF THE INVENTION & PRIOR ART

Traditional teaching of medical information and skills has involved hands-on experience through models, mannequins, and live actors posing as patients, and cadaveric work.^{1,2} All of these enable the student to work with either a real human body or a tangible three-dimensional facsimile thereof, and provide the student with opportunity for active learning. The concept of “see one, do one, teach one” has long guided medical education; in November 2024, Google Scholar returned “about 429” results for ‘“see one, do one, teach one” medicine’ when limited to results since 2024. Miller, back in 1990,³ noted the value of models as a substitute for reality in the context of both teaching and evaluating medical student knowledge. Even today, literature suggests that active student engagement yields better outcomes.⁴

However, the invisible nature of X-rays and their nature as damaging radiation⁵⁻⁷ confounds this approach; teaching with actual X-rays is not practical for the majority of cases. Instead, students are taught with a combination of the review of existing radiographs,^{8,9} in some cases with a pictorial or descriptive overlay of the anatomical structures depicted, which describe what is or can be seen on a radiograph;¹⁰⁻¹³ and models—live or artificial, in-person or via imagery—which describe proper patient positioning vis-à-vis the X-ray emitter and detector (e.g. film).¹⁰

These teaching modalities place students in a passive role, however, rather than enabling them to actively engage with the material. Students might be given access to the model, and may practice aligning it with an X-ray emitter and detector, but they can't see the results of their work—there is neither discovery nor feedback from the model. A radiograph may be presented with a patient history, but the radiograph and the history are merely presented, and not available for interaction. Further, the current state of teaching requires the student to accept the function of an X-ray on faith: invisible rays strike an opaque object, revealing some of what's inside, perhaps by magic. Even if the physics behind an X-ray machine and film are discussed, the process remains one of presentation, not interaction.

Thus, teaching of radiology, including X-ray imaging, to medical professionals remains a challenge, with students feeling unprepared by current teaching methodologies and having poor confidence in their ability to interpret what they are seeing.⁴ At the same time, medical imaging is a growing area of importance in modern medicine.^{4,14,15} X-ray, though an older methodology than CT and MRI, remains an important tool for diagnosis^{4,16,17}and treatment.^{14,15,18}

Additionally, an increasing number of medical techniques are or can be guided by X-rays (e.g.^{14,15,17,19,20}, all of which were issued in the last week of November 2024). A need exists for students to learn these techniques without this exposure, and for practitioners to practice these techniques, again without radiation exposure.¹⁸

Prior work on the elimination of damaging radiation from teaching the use of X-ray imaging has included the use of visible light, but either assumes that the student already understands the nature of how X-rays work (i.e. how to read and comprehend a radiograph) or applies the concept in limited, highly specific circumstances. Also, the subject of lucency (i.e. varied degrees of transparency, such as (but not limited to) to visible light or X-rays), such as in the bones of a patient with osteoporosis or Paget disease, for evaluating interstitial or hilar markings of the lung, and for identifying bony features, is not explored.

For example, U.S. Pat. No. 3,348,319²¹ describes a transparent block, embedded with structures variously transparent and opaque to X-ray and to visible light. A radiograph of the block is taken, then compared directly to the block; embedded structures can be compared between the block and the radiograph. However, the device described is intended for viewing by a single viewer at a time (there is a viewing aperture permitting only a single viewer), and while the radiograph is (obviously) 2-D, the student must compare it directly to the 3-D subject (block).

U.S. Pat. No. 4,200,996²² describes a device that incorporates a plastic skull cast and a simulated dental X-ray emitter, which displays pre-made X-ray films in the base of the device, based on the orientation of the (simulated) emitter to the skull. In that device, however, the X-ray images were premade rather than a result of light emitted from the emitter to generate shadows cast by the skull, requiring again a take-it-on-faith approach and offering limited feedback to the learner.

Soviet patent SU1051562A1²³ describes a pair of identical or near-identical models, mounted together on a rod and arranged in-register (i.e. with the same orientation, etc.). The lower model is housed in a box that includes a light source at one end and a viewing screen at the other, such that when the light is illuminated, the shadow of the lower model is cast onto the screen. Rotating the upper model rotates the lower model to the same degree, changing the resulting shadow. While this device allows the student to manipulate the subject of a shadow, it only allows an indirect, limited method of doing so. The student cannot, for instance, touch a portion of the subject model and see on the image the shadow of their finger and the portion of the model they've touched. Nor can the instructor, perhaps in response to a student question, place a marker on a feature of the model and discuss the resulting change of the shadow. Nor can the distance between the subject and the viewing screen be changed. Finally, this device requires two identical models, which must be properly synchronized. Since the model generating the image cannot be seen directly, there is again a take-it-on-faith approach.

U.S. Pat. No. 9,192,301,²⁴ describes a device in which a mannequin, previously keyed to a computer model (data model), is stationed between a mock X-ray emitter and detector. Based on the sensed location and orientation of the mannequin, an attached computer queries the computer model and returns a simulated image. While that invention does allow a student to see, judge, and learn from the results of their work, it requires expensive computational assets and specialized equipment, and retains the ‘black box’, take-it-on-faith aspect of teaching. Related, the image is not an actual shadow, but is a best-guess based on the computer's understanding of how the mannequin is positioned, requiring additional aspect of take-it-on-faith to apply to radiology

Korean patent KR101591775B1²⁵ describes a device for simulating fluoroscopic vascular access via visible light and shadow. However, it relies on a camera and monitor, and requires specialized armatures to hold its model, camera, and light source. The spatial relationship between the light and camera is relatively fixed, as is the relationship between the model and the other components. Thus, while that invention is well suited for teaching and demonstration of the use of X-rays in vascular surgery, it cannot be used for other scenarios. Further, since its monitor faithfully reproduces what is seen by the camera (i.e. without image processing), it cannot be said to truly replicate an X-ray. Specifically, while a video of a 3-D space is common and thus readily understood in its three dimensions by the typical viewer, an X-ray's depiction of 3-D space is distinct, with superimposition and magnification characteristics that are unexpected, potentially counterintuitive, to the untutored viewer.

U.S. Pat. No. 10,531,064²⁶ describes a process by which light is shone onto a 3-D subject to create a shadow, however the shadow thus created is intended for analysis by a computer as an intermediate step toward creating a 3-D computer model of the original subject, as for 3-D printing. Unlike the present invention, the shadow is neither intended nor situated for human analysis, nor for presentation nor teaching.

Chinese patent CN214475919U²⁷ utilizes a transparent model in the context of training for minimally invasive spinal surgery, including a screen and a camera—shadow of the model, displayed on the screen, is captured by the camera and only accessible by video monitor. While that device is useful within its field, it again assumes that the user has a working knowledge of radiology, and by design is restricted to a narrow family of surgical techniques.

Patent 2024/0339047²⁸ uses a semi-transparent subject (model) with visible light. That patent, through the use of nodes and transparency, allows exploration of structures in different layers of a subject. However, the very nodes that allow for exploration of the third dimension also remove the subject from the reality of radiology, in which structures need to be understood by their own shapes on a resulting image, without the addition of nodes to the native structure. While that patent is therefore useful in teaching some of the basics of collapsing a 3-D structure into a 2-D image, it falls short in teaching how actual structures will appear on an actual radiograph, or how a subject will appear on a technical drawing. It also assumes, though it does not specify, that the nodes are opaque rather than color-coded; notwithstanding the previous point, if a model of this type is to discriminate between structures on different sides of the model, opaque nodes will obscure each other. Differently-colored translucent nodes could be discriminated even when superimposed. Finally, that invention assumes the use of a standard projection screen, and therefore either requires exaggerated space between the subject and its image or submits to the encumbrance of the subject obscuring the use of its image. In the first case, the image is artificially magnified (a problem in some radiological-based diagnoses) and less distinct, while in the second case, the image is difficult to see.

U.S. Pat. No. 12,002,376¹⁸ demonstrates how to use fluorescence with visible light in a model, rather than X-ray illumination, when training students in catheter insertion, but that invention requires special fluorescent materials and is limited to the specific scenario of inserting a catheter into a blood vessel. Further, it also assumes that the user has a basic understanding of how to read a radiograph.

U.S. Pat. No. 12,002,377²⁹ describes a device for demonstrating the superimposition of two subjects, but that device is limited to the specific scenario of two teeth and, importantly, uses opaque subjects (posts with differing silhouettes) restricting it to exploring features contributing to the outline of its subject. The spines of the vertebral column, as seen in a frontal chest X-ray, cannot be explored with their invention; nor does their invention lend itself to exploring the magnification of a subject's image as that subject is moved away from the X-ray film (detector); nor does their invention allow for an exploration of varied lucency in a subject. Finally, the subjects of study, from which the images are created, are bound to a board, with limited mobility.

Thus, while prior art has at times utilized visible light and shadow as a proxy for X-rays, it has only done so in narrowly defined circumstances, has generally overlooked the importance of lucency, and has not utilized color coding of regions or parts of the subject of a study. Assembling a complete whole of visible light and shadow; varying degrees of translucency (including transparency and opacity) in a subject; color coding of a subject; permitting direct, unobstructed viewer access and manipulation of the subject, light source, and screen; and permitting free movement of the subject, light source, and screen; has yet to be described. Nor have the above characteristics been given the benefit of a rear-projection writing surface.

### SUMMARY OF THE INVENTION

The present invention relies on visible light and shadow, obviating the need for protective measures and enabling simultaneous viewing of a subject and its resulting 2-D image. In essence, the subject of the study—such as the skeleton in FIG. 1—is used as a 3-D shadow-puppet, and students are allowed (encouraged) to compare the puppet and its 2-D image. Importantly, the subject itself generates its image. Equally importantly, the subject can be directly and freely interacted while the image is being generated, with the results of manipulation being seen in the subject's shadow.

More specifically, the present invention reproduces a radiograph using visible light. A light source replaces the X-ray emitter; a subject of study is chosen for its shape, translucency and opacity to visible light; and a viewing screen replaces the X-ray film or detector. When the light source is shone on the subject, the resulting shadow on the screen is analogous to a completed radiograph. Moving any of the components yields immediate changes in the image on the screen.

For the student learning radiography, this invention allows the student to directly manipulate the subject and detector (film, screen) of a mock radiograph and immediately see the differences in the resulting image, and to do so as many times as desired, for as long as desired, without fear of radiation injury and without the encumbrance of generating, monitoring, or protecting from damaging radiation. For the clinician learning or practicing a radio-guided technique, similar advantages apply. For the student of technical drawing, the present invention displays a 3-D object and its 2-D image together, with clear relationship between the two (i.e. it is clear how the 2-D image is extracted from the 3-D subject). The benign nature of all components allows them to be stored and deployed anywhere, including during a live lecture or in a break room.

The present invention also applies to demonstration of techniques such as positron emission tomography (PET) if a light source (or reflector) is concentrated inside a translucent or transparent model.

By using subjects of varying opacity, size, shape, color, and reflectance, the concepts of radiolucency, attenuation, superimposition, and artifact can be explored. By manipulation of the subject (e.g., rotating it on various axes, adding or removing parts), students can see the changes in the resulting image, in real time, side-by-side with the 3-D subject responsible for the image. By moving the subject closer to and further away from the screen, the concept of magnification can be explored (e.g., cardiothoracic ratio in a PA (posterior-anterior) versus an AP (anterior-posterior) chest X-ray). The technical quality of a radiograph (e.g., subject positioning, exposure) can also be explored, even more-so if the intensity of the light used is varied.

In a larger sense, this invention allows exploration of the relationship between a 3-D subject and its 2-D depictions, such as between a machine part and its technical drawings or between a building and its blueprints. Thus, by substituting in an appropriate subject, this invention applies to the instruction of not only medical professionals, but also to those in architecture, engineering, and any profession whose practitioners must understand 3-D objects via 2-D depictions. As an example, using a machine part as the subject generates an image which can be compared to a technical drawing of that machine part.

### BRIEF DESCRIPTION OF DRAWINGS

FIG. 1 describes a lateral view of the invention, including the light source, model (a skeleton, in this case) and screen, as seen from the side.

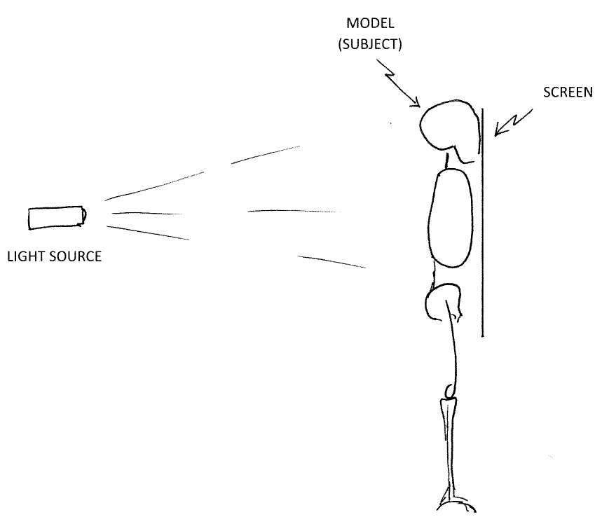

### DETAILED DESCRIPTION OF THE INVENTION

The invention consists, at minimum of three parts:
A light source
A subject
A viewing screen

Optionally, remote-viewing setups can be used instead of or in addition to the viewing screen. Models (including, but not limited to, mannequins) designed to work with this method of demonstration are an obvious extension of this invention and are included here by reference.

### Light Source

A single light source is used. Optimally, a spotlight, focused to give a sharply-edged shadow, is employed. An embodiment of this invention using an ellipsoidal reflector spotlight (an Altman 4.5-2550Z—MT baby zoom) produced excellent results, with sharp, clear display on the viewing screen. The shutters enabled restricting the light spread to the viewing screen, eliminating glare that would be caused by light passing beside the screen and making viewing of the image comfortable. However, a basic flashlight of sufficient power will also produce useful results, and an embodiment with a three D-cell LED Maglite produced a useable demonstration. Regardless of the device used as a light source, key is for the light source to cast a sharply-defined shadow on the screen.

### Subject

Subjects are chosen based on shape and translucency (including, or not, transparent and/or opaque regions), and based on the goals of the use session. A hanging skeleton is an obvious choice for medical teaching and will appear on the screen similar to the way bones appear on X-ray, though only as a silhouette unless it is constructed from translucent material. Glass bottles will show their embossed patterns on the screen, mimicking the way spines (projections) and fossae (hollows) appear on bones on actual X-ray, and will show their walls in the darkened edges of their shadows, much as bones do. The embossed patterns equally resemble certain technical drawings, in which recessed or projecting features of the subject matter are included. Though as yet there appear to be no models constructed of translucent materials, their use would bring this invention to its full realization, and they are included in this invention by extension. Auxiliary subject matter may include markers, possibly pinned or wired to the main subject, for indicating features of the main subject and/or mimicking the R and L markers (among others) used by radiologists to indicate the right and left sides of a patient or nature of a radiograph's view.

Subjects may include transparent/translucent colored material, making colored shadows on the screen. This may be useful to, for instance, color-code portions of the subject to draw attention to the corresponding portion of the subject's shadow.

If the subject is or includes material that will show up on X-ray, it can also be X-rayed, and the resulting radiograph(s) compared to the shadow(s) cast by visible light, allowing side-by-side comparison between the two images and the subject itself.

### Screen

Optimally, the screen should be suitable for rear-projection. Implementations using front projection were useable, but cumbersome, as the subject either obscured viewing of its own image or was too far away from the screen to generate accurate imagery (i.e. blurring and magnification were an issue). Regardless, it must provide for crisp imagery. Also optimal is a markable screen, as this allows markup of the resulting image. A markable rear-projection screen, for example as described in U.S. Pat. No. 9,541,816³⁰, yields superior results; however, a sheet of paper of adequate dimensions to display the shadow, of adequate composition to display crisp shadows when backlit, and properly supported to allow annotation, would serve equally well. Lacking such a translucent, writable surface, any projection setup where viewers can see both the subject and the resulting image will do.

A traditional screen may be augmented or replaced by a live-stream setup, mimicking the arrangement of radiologically-guided techniques (e.g. fluoroscopy).

### Layout

For most embodiments, the light source should approach the screen at or near a 90-degree angle so as to minimize keystoning (distortion of a projected image cause by the light approaching the screen obliquely³¹). For students of radiology, this mimics the arrangement of X-ray machine. For students of technical drawing, this replicates the relationship between the 3-D subject of a drawing and its 2-D representation. However, there are scenarios in which it is advantageous for the light to approach obliquely, such as when demonstrating or exploring the importance of an X-ray approaching its detector at 90 degrees (for instance, when instructing student X-ray technicians on proper alignment of patient, emitter, and detector). Consequently, the present invention will have the most utility if the light source is not rigidly aligned with the screen.

In placing the screen, it is imperative that both the subject and its image are accessible. If the screen is only suitable for front projection, its display side should face the light source and the subject, with the three components arranged so that light from the source strikes the subject, then the screen, with the shadow of the subject falling onto the screen. If the screen is suitable for rear projection, the components should be arranged so the light source strikes the subject, then the rear of the screen, with the shadow of the subject falling onto the screen.

The screen may be supplemented or replaced with a remote viewing setup, for example with a camera pointed at the screen, transmitting to a video monitor. Depending on the goals of the use session, a camera pointed at the back of a rear-projection screen will best mimic an X-ray setup, for instance when practicing fluoroscopic techniques. If the invention is being used in a lecture hall, a mobile camera, able to move between the subject and it image, may be more suitable.

1. A method for teaching or demonstrating radiology comprising a light source, an object to be studied, and a screen, with access for the viewer to both the object to be studied and the screen.

2. A method for teaching or demonstrating radiology, as in claim 1, utilizing a rear-projection screen.

3. A method for teaching or demonstrating the relationship between 2-D images and 3-D objects, as by claim 1.

4. A method for teaching or demonstrating the relationship between 2-D images and 3-D objects, as by claim 2.

5. A method for demonstrating or practicing x-ray guided techniques, by adding or substituting a video or video-type feed to or for the screen in claim 1.

6. A method for demonstrating or practicing x-ray guided techniques, including but not limited to fluoroscopy, by adding or substituting a video or video-type feed to or for the screen in claim 2.

7. A model, designed to work with the method of claim 1, which may include materials of various translucency, transparency, opacity, and color.

8. A model, designed to work with the method of claim 2, which may include materials of various translucency, transparency, opacity, and color.

9. A model, designed to work with the method of claim 3, which may include materials of various translucency, transparency, opacity, and color.

10. A model, designed to work with the method of claim 4, which may include materials of various translucency, transparency, opacity, and color.

11. A model, designed to work with the method of claim 5, which may include materials of various translucency, transparency, opacity, and color.

12. A model, designed to work with the method of claim 6, which may include materials of various translucency, transparency, opacity, and color.
